(19) United States
(12) Patent Application Publication
(10) Pub. No.: US 2002/0177369 A1
(43) Pub. Date: Nov. 28, 2002

(54) RJ modular connector having printed circuit board having conductive trade to balance electrical couplings between terminals

(76) Inventor: James Hyland, Harrisburg, PA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/190,395

(22) Filed: Jul. 2, 2002

Related U.S. Application Data
(63) Continuation of application No. 09/863,942, filed on May 22, 2001, now Pat. No. 6,413,121.

(51) Int. Cl. H01R 24/00

(52) U.S. Cl. 439/676

(57) ABSTRACT

A RJ modular connector comprises a housing defining a plug receiving section, and a terminal core receiving section. A terminal core is received in the terminal core receiving section and includes a plurality of terminals. A substrate is provided having a conductive traces thereon. The terminals are securely mounted onto the substrate. An electrical connection is established between a first terminal and the conductive trace, and portion of the conductive trace is arranged to create a first electrical coupling between the first and third terminals thereby balancing a second electrical coupling between the first terminal and a second terminal arranged between the first and third terminals.

### FIELD OF THE INVENTION

The present invention relates to a RJ modular connector, and more particularly to a RJ modular connector having a substrate provided therein to balance electrical couplings between terminals.

### DESCIRPTION OF THE PRIOR ART

RJ modular connector has been widely used in telecommunication system since it was firstly created. A so-called RJ45 modular connector has been widely used in the network system.

The RJ45 modular connector includes totally eight terminals. Resulting from miniaturization of the computer, all corresponding components, including connectors, have to be reduced for their dimension and size. One of the negative consequences or problem created from miniaturization is electrical coupling between terminals. When the RJ connector is used in low speed signal transmission, the couplings between adjacent terminals can be ignored in light of its effect. However, when the RJ connector is used for high speed signal transmission, the couplings between adjacent terminals create a great problem. Unless the electrical coupling can be effectively controlled within an accepted level, it is unlikely that the RJ 45 modular connector can be used in the high-speed signal transmission.

One of the approaches is to select a pair of terminals as a differential pair. In the differential pair, two terminals transmit the same signal but with inverted phase. By this arrangement, the couplings coupled thereto can be finally subtracted in a data processing unit.

As shown in the catalog from The Siemon Company which will be submitted later with IDS, there are at least eight different patterns in selecting terminals as differential pair, i.e. T568A, T568B, USOC 4-pair, USOC 1-, 2-or 3-pair, 10BASE-T (802.3), Token Ring (802.5), 3-pair (MMJ), and TP-PMD (X3T9.5) and ATM. In each implementation, two terminals are selected as a pair in which some are close to each other, while some are apart from each other. Each pattern has its own uniqueness, while each also carries a coupling issue need to be solved.

Among those patterns, T568A and T568B are widely used and in T568A, terminals 1, 2 configure 3^{rd} pair, terminals 3, 6 configure 2^{nd} pair, terminals 4, 5 configure 1^{st} pair, while terminals 7, 8 configure 4^{th} pair. In T568B, terminals 1, 2 configure 2^{nd} pair, terminals 3, 6 configure 3^{rd} pair, terminals 4, 5 configure 1^{st} pair, while terminals 7, 8 configure 4^{th} pair.

Since those eight terminals are equally spaced, electrical couplings between terminals will surely create some problems, i.e. coupling or cross-talk. For example, if we take terminal 3 into consideration, terminal 3 will naturally pick up energy coupled from terminals 2, and 4 which are close to terminal 3. On the other hand, terminal 6, which carries signal having inverted phase of the signal carried by terminal 3, will also pick up energy coupled from terminals 5 and 7. However, energy coupled into terminals 3, 6 from terminals 2 and 7 can not be suitably eliminated because terminals 3, 6 is unlikely to establish couplings between terminals 1 and terminals 8 to balance the couplings between terminals 2, 3 and 6, 7. Accordingly, signals transmitted by terminals 3, 6 carry noises generated by their adjacent terminals 2, 7. In addition, terminals 3 and 6 will also carry noises coupled thereto from terminals 4, 5 and which couplings should be also carefully taken to avoid certain noises.

In order to decrease the effects of electrical coupling between the (3^{rd}, 4^{th}) and (3^{rd}, 2^{nd}) terminals, and (6^{th}, 5^{th}) and (6^{th}, 7^{th}) terminals, many approaches have been provided, such as creating electrical couplings between 3^{rd} and 1^{st} terminals and 3^{rd} and 5^{th} terminals, to balance the electrical coupling between the 3^{rd} and 2^{nd} terminals and 3^{rd} and 4^{th} terminals, and creating electrical coupling between 6^{th} and 8^{th} terminals and 6^{th} and 5^{th} terminals to balance the electrical couplings between the 6^{th} and 7^{th} terminals and 6^{th} and 4^{th} terminals.

However, as mentioned above, those eight terminals are arranged in a common plane, it is impossible to create those balancing electrical couplings, i.e. (1^{st}, 3^{rd})(3^{rd}, 5^{th}), and (4^{th}, 6^{th}) (6^{th}, 8^{th}) terminals when all terminals are located in the same level, it is unlikely to create any electrical channels therebetween to create those electrical couplings accordingly.

The Siemon Company, a US company, discloses a solution posted on the Internet, http://www.siemon.com/white papers/99-08-30-through-hole.asp. A hard copy thereof will be submitted with IDS for reference.

As clearly shown in FIG. 4 of that reference, 6^{th} and 2^{nd} terminals are arranged in the first layer, while 8^{th}, 5^{th}, 4^{th}, and 1^{st} terminals are arranged in the second layer, and 7^{th} and 3^{rd} terminals are arranged in the third layer.

The 6^{th} terminal in the first layer has a rectangular loop having its longitudinal sides aligned with terminals 4^{th} and 8^{th} located in the second layer, while terminal 3 in the third layer also has a rectangular loop having its longitudinal sides aligned with terminals 5^{th} and 1^{st} located in the second layer.

In addition, the right longitudinal loop side of the terminal 6^{th} further includes a square corresponding to a square formed in terminal 4^{th}. The left longitudinal loop side of the terminal 3 includes also a square with respect to the square formed on terminal 8^{th}.

Arrangements suggested by Siemon are to increase the couplings between (1^{st}, 3^{rd}), (3^{rd}, 5^{th}), and (4^{th}, 6^{th}) (6^{th}, 8^{th}) terminals thereby helping to balance electrical couplings of the terminals.

However, those eight or four set sets of terminals are arranged in three different layers, and each set of terminals are separately divided by an insulative sheet material. This will no doubt increase the complexity of the connector.

In addition, there are five different shapes and configurations among those eight terminals. Each terminal has its own shape which is different from each other, especially the 3^{rd} and 6^{th} terminals, each including the rectangular loop portion which overlap to corresponding terminals to create wanted electrical couplings. Each loop further forms the square to increase the electrical couplings with corresponding terminals having the square. The electrical couplings created can help to meet higher system requirement. The eight different configuration of the terminals will surely increase the difficulty and complexity in production.

There are some other approaches that including routing terminal tails of those 3^{rd}, 6^{th} and 4^{th}, 5^{th} terminals to alter their position and affect couplings between 3^{rd}, 2^{nd} and 3^{rd}, 4^{th}; and 6^{th}, 5^{th}, and 6^{th}, 7^{th} terminals. However routing terminal tails will inevitably increase the manufacturing cost.

U.S. Pat. No. 6,120,329 issued to Steinman on Sep. 19, 2000, discloses another approach to solve the above-addressed problem. Again, terminals are configured with different shapes and dimensions making the production complex.

U.S. Pat. No. 5,069,641 issued to Sakamoto et al. discloses a suggestion of using printed circuit board in the RJ modular housing, however, it addresses to different issues.

### SUMMARY OF THE INVENTION

It is an object of this invention to provide an RJ modular connector, and more particularly to a RJ modular connector having a substrate with conductive traces provided therein to balance electrical couplings between terminals.

It is still an object of this invention to provide a RJ modular connector which can be easily manufactured.

In order to achieve the objective set forth, an RJ modular connector in accordance with the present invention comprises a housing defining a plug receiving section, and a terminal core receiving section. A terminal core is received in the terminal core receiving section and includes a plurality of terminals. A substrate is provided having conductive trace thereon. The terminals are securely mounted onto the substrate. An electrical connection is established between a first terminal and the conductive trace, and a portion of the conductive trace is arranged to create a first electrical coupling between the first terminal and a third terminal thereby balancing a second electrical coupling between the first terminal and a second terminal arranged between the first and third terminals.

### BRIEF DESCRIPTION OF THE DRAWINGS

Other objects and further features of the present invention will be apparent from the following detailed description when read in conjunction with the accompanying drawings, in which:

FIG. 1A is a perspective view of a RJ modular connector in accordance with the present invention;

FIG. 1B is a front view of FIG. 1A;

FIG. 1C is similar to FIG. 1A except viewed from a reverse direction;

FIG. 1D is a front view of FIG. 1C;

FIG. 1E is an exploded view of FIG. 1C;

FIG. 2A is a bottom view of a top substrate;

FIG. 2B is a top view of FIG. 2A;

FIG. 2C is a top view of a bottom substrate;

FIG. 2D is a bottom view of FIG. 2C;

FIG. 3A is an exploded view of a terminal insert in accordance with the present invention;

FIG. 3B is similar to FIG. 3A with terminals attached to the lower substrate;

FIG. 3C is an assembled view;

FIG. 3D is an assembled view taken from reverse direction of FIG. 3B;

FIG. 3E is a cross sectional view taken from line 3-3 of FIG. 3B;

FIG. 3F is an exploded view of the terminal insert with carrier attached thereto; FIG. 4 is a second embodiment of a terminal insert in accordance with the present invention.

### DETAILED DESCRIPTION OF PREFERRED EMBODIMENTS

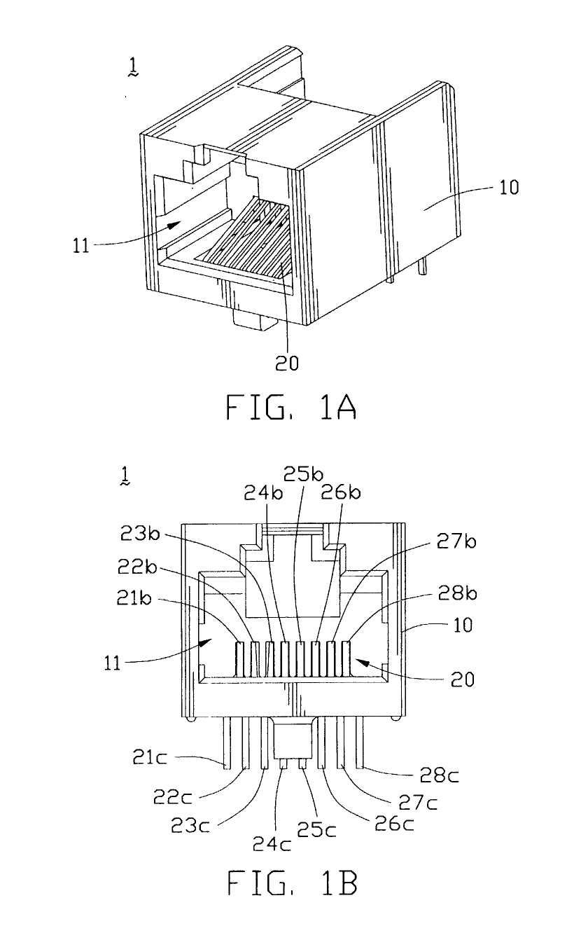

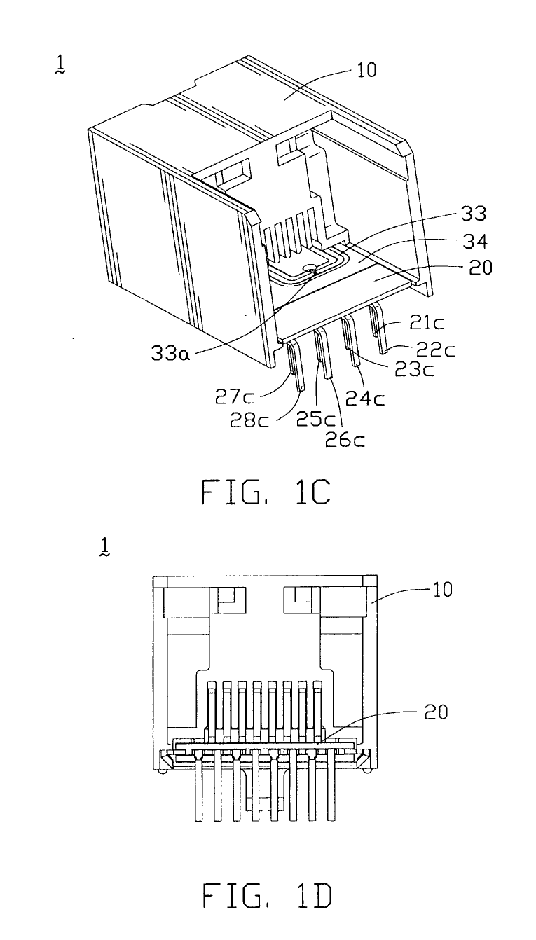

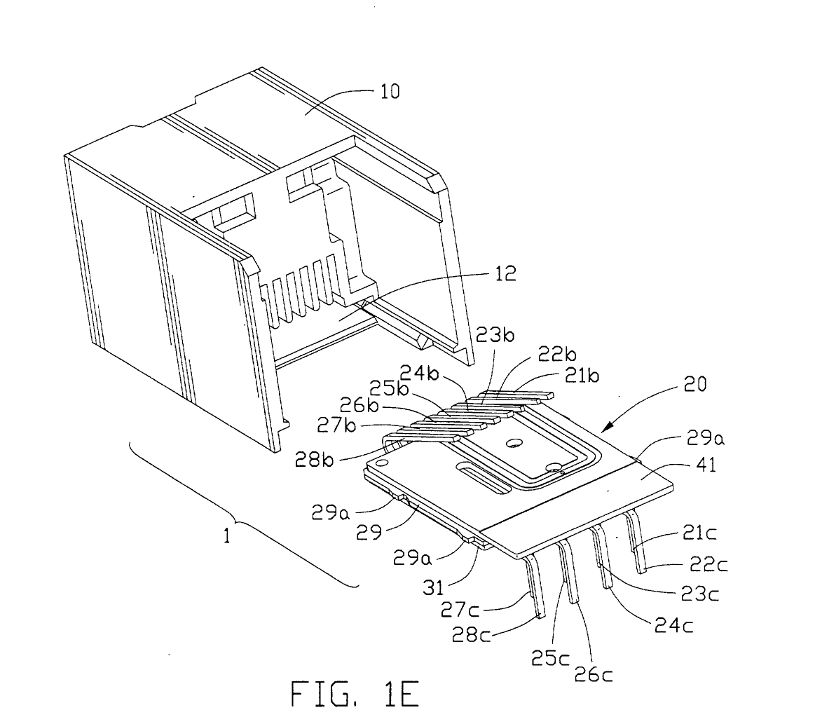

Referring FIGS. 1A to 1E, a RJ modular connector 1 in accordance with the present invention includes a housing 10 defining a plug receiving space 11, and a terminal insert receiving space 12 in which a modular terminal insert 20 securely attached therein and with contacting portions 21b, 22b, 23b, 24b, 25b, 26b, 27b, and 28b extending into the plug receiving space 11, while leg portions 21c, 22c, 23c, 24c, 25c, 26c, 27c and 28c extending away from the housing 10. The RJ modular connector 1 has a general dimension and shape corresponding to existing industry specifications. Accordingly, no details are given thereto. The unique feature of the present invention resides on providing the modular terminal insert 20 which can be simply made in a cost-effective manner. In addition, the modular terminal insert 20 is arranged such that electrical couplings can be created between selected terminals to balance electrical couplings between selected terminals. By this arrangement, cross-talk between certain terminals can be effectively eliminated or reduced.

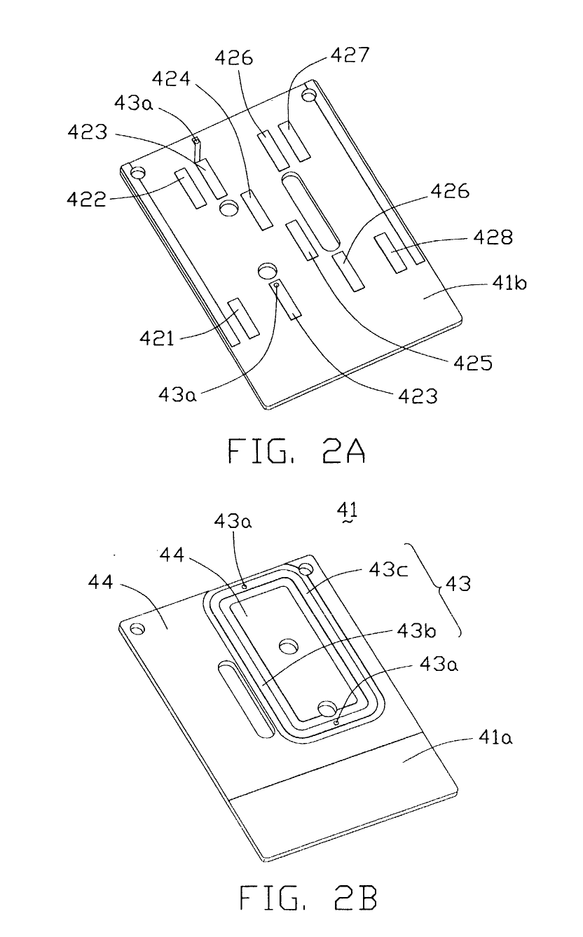

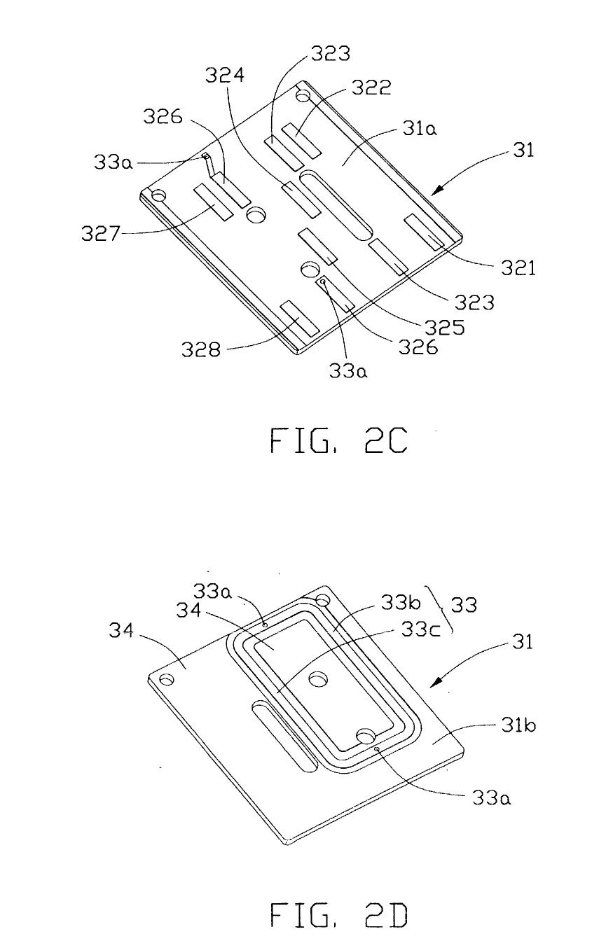

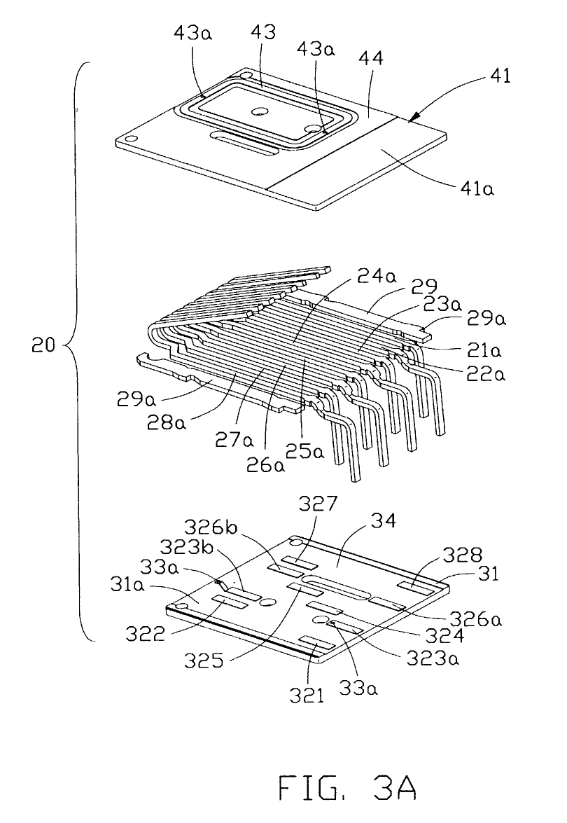

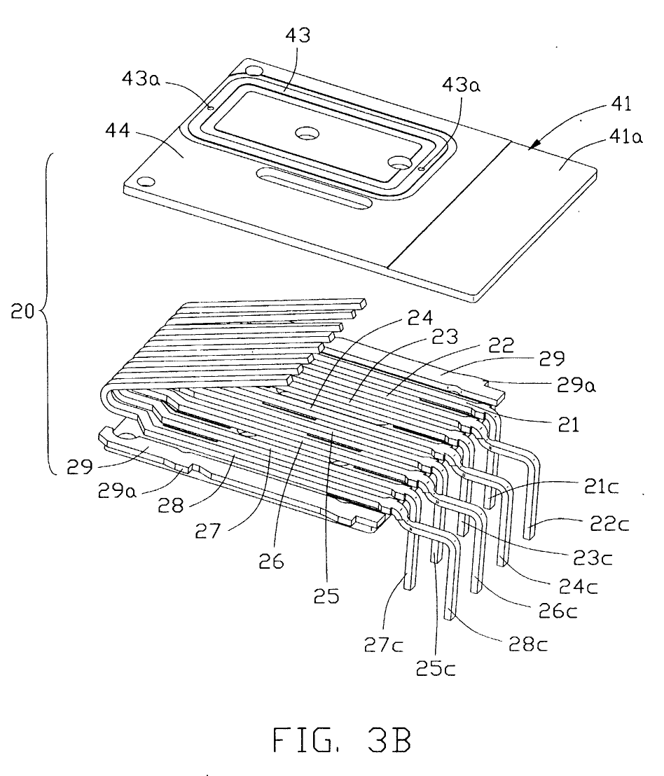

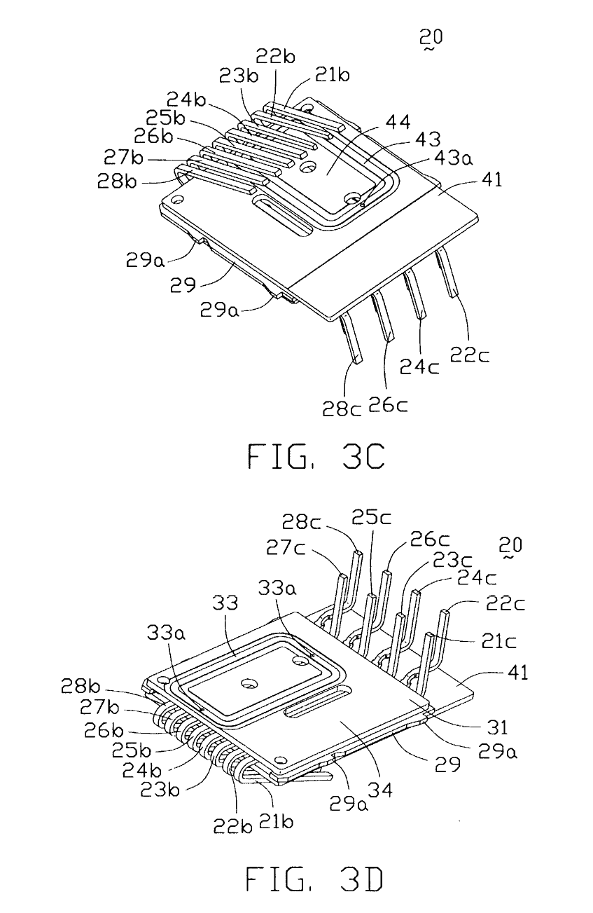

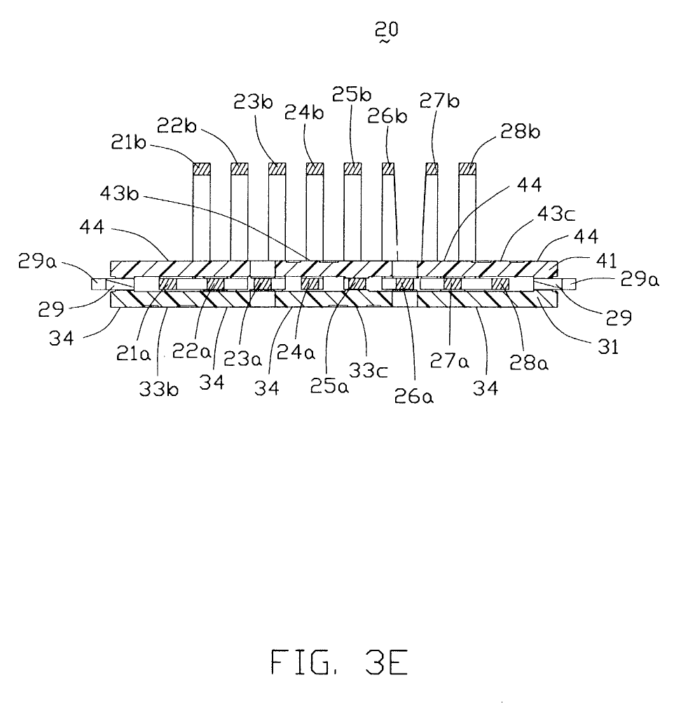

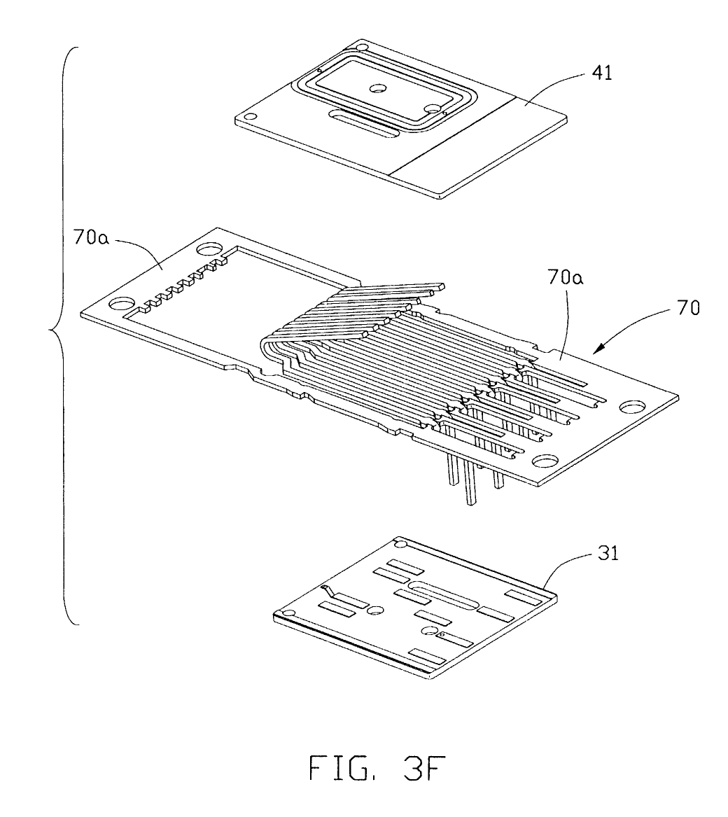

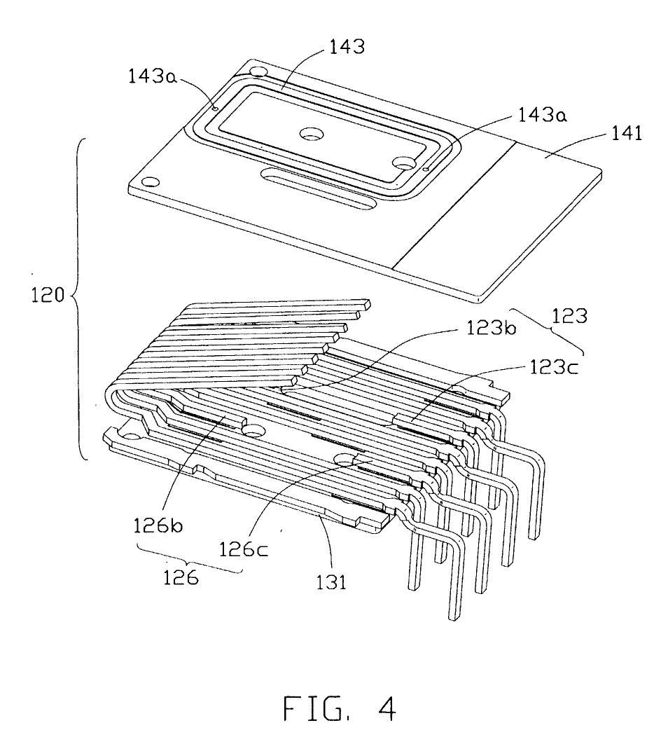

Referring to FIGS. 2A to 2D in conjunction with FIGS. 3A to 3F, the terminal insert 20 in accordance with the present invention includes a plurality of terminals 21, 22, 23, 24, 25, 26, 27, and 28 sandwiched between lower and upper or first and second printed circuit boards 31 and 41. Among the terminals, terminals 21, 22 configures a first pair, terminals 23, 26 configures a second pair, terminals 24, 25 configures a third pair, while terminals 27, 28 configures a fourth pair.

The lower printed circuit board 31 defines first (top) and second (bottom) surfaces 31a, 31b and with conductive footprints or conductive pads 321, 322, 323, 324, 325, 326, 327 and 328 formed on the first face 31a. A conductive loop 33 is formed on the second face 31b and surrounded by a grounding plane 34. The conductive loop 33 is electrically connected to the conductive footprints 323 by means of tunnels 33a. Since the tunnel 33a is a configured by a through-hole coated with conductive material, such as solder, and is known to the skill in the art, no details are given herebelow.

The upper printed circuit board 41 defines first (top) and second (bottom) surfaces 41a, 41b and with conductive footprints or conductive pads 421, 422, 423, 424, 425, 426, 427 and 428 formed on the second face 41b. A conductive loop 43 is formed on the first face 41a and surrounded by a grounding plane 44. The conductive loop 43 is electrically connected to the conductive footprints 426 by means of tunnels 43a which is identical to the tunnels 33a.

Among the footprints 321, 322, 323, 324, 325, 326, 327 and 328, the footprint 323 corresponding to terminal 23 includes first and second portions 323a, 323b ; while footprint 326 with respect to terminal 26 includes also first and second portions 326a, 326b. Among the footprints 421, 422, 423, 424, 425, 426, 427 and 428, the footprint 426 with respect to the terminal 26 includes first and second portions 426a, 426b; while footprint 423 with respect to the terminal 23 includes also first and second portions 423a, 423b.

The terminals 21, 22, 23, 24, 25, 26, 27, and 28 can be securely sandwiched between the printed circuit boards 31, 41 by applying solder pastes on the footprints 321, 322, 323, 324, 325, 326, 327 and 328; and footprints 421, 422, 423, 424, 425, 426, 427 and 428, and then reflowing the solder pastes such that the terminals 21, 22, 23, 24, 25, 26, 27, and 28 are completely and securely attached to the footprints 321, 322, 323, 324, 325, 326, 327 and 328 of the lower printed circuit board 31; and footprints 421, 422, 423, 424, 425, 426, 427 and 428 of the upper printed circuit board 41.

As clearly shown in FIGS. 2B 2D and 3E, the conductive trace 33 formed on the bottom (second) face of the first substrate 31 includes first and second portions 33b, 33c which are aligned with terminals 21 and 25, while the conductive trace 43 formed on upper (first) face of the substrate 41 includes first and second portions 43b, 43c which are aligned with terminals 24 and 28. Accordingly, electrical couplings will be generated between the first portion 33b and the terminal 21, and the second portion 33c and the terminal 25. By the same reason, electrical couplings will be generated between the first portion 43b and the terminal 24, and the second portion 43c and the terminal 28.

As it can be readily appreciated, the electrical coupling between the third terminal 23 and the first terminal 21 by means of the conductive trace 33 (via first portion 33b) will properly help to balance the electrical coupling between the third terminal 23 and the second terminal 22. While, the electrical coupling between the sixth terminal 26 and the eighth terminal 28 by means of the conductive trace 43 (via second portion 43c) will also properly help to balance the electrical coupling between the sixth terminal 26 and the seventh terminal 27. As a result, the energy coupled into terminals 23, 26 from terminals 22, 27 can be more properly balanced by the introduction of the electrical couplings between the terminals 23, 26 with respect to the terminals 21 and 28, respectively. As a result, the signal transmitted through the differential pair terminals 23, 26 benefits from balanced coupling from its adjacent terminals, such as terminals 22 and 27.

As it can be readily seen from FIG. 3F, the manufacturing of the terminal insert 20 is comparatively simple as compared to the prior art in which the terminals 21 to 28 are integrally molded or assembled together. In the present invention, the terminals 21 to 28 can be simply stamped from a sheet metal 70. Then the terminals 21 to 28 can be easily sandwiched by the first and second substrate 31, 41. The carrier 70a can be simply trimmed off after the terminals 21 to 28 are securely attached and sandwiched between the first and second substrates 31 and 41.

In addition, it can be readily appreciated that during the stamping of the terminals 21 to 28, retaining beam 29 having barbs 29a can be also formed on the sheet metal 70 and which are also attached and sandwiched between the first and second substrates 31 and 41 by solder. Accordingly, the terminal insert 20 resulted therefrom can be easily inserted into the terminal insert receiving space 11 and securely attached therein by the barbs 29a.

Referring to FIG. 4, a second embodiment of a terminal insert 120 in accordance with the present invention is disclosed. In the second embodiment, the base portion (not shown) of the 3^{rd} terminal 123 and the base portion (not shown) of the 6^{th} terminal 126 are cut-off such that the contact portion 126b and the leg portion 126c are electrically connected by the conductive loop by tunnels of a first substrate 131, while the contact portion 123b and the leg portion 123c are electrically connected by the conductive loop 143 by tunnels 143a of a second substrate 141.

Even the above embodiment uses patterns of T568A and T568B to illustrate the spirit of the present invention, it can be readily appreciated that coupling issues from other patterns, such as 3-Pair MMJ, USOC 4-pair, and TP-PMD (X3T9.5) and ATM can also be helped out by the teaching of the present invention without creating complex configuration of the terminals. By the teaching of the present invention, the terminals can be made as simple as existing terminals, while the coupling issue can be taken care by the printed circuit board.

Even the present invention illustrate is best mode of embodiments by establishing electrical couplings between conductive loops and corresponding terminals, it can be readily appreciated that the electrical couplings can be also created via conductive loops and conductive pads on which terminals are electrically connected thereto, i.e. terminals head and tails are connected to the conductive pads extending through a substrate, while the conductive loop and the conductive pads are arranged to create electrical coupling to balance electrical couplings among terminals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. A RJ modular connector, comprising:
a housing defining a plug receiving section, and a terminal core receiving section;
a terminal core received in said terminal core receiving section, wherein said terminal core is configured by at least a plurality of terminals attached to conductive pads formed on a first surface of said substrate; and
at least a terminal being electrically separated into first and second sectors and being electrically connected by a conductive trace provided by said substrate.

2. The RJ modular connector as recited in claim 1, wherein said conductive trace includes a first portion which is arranged such that said first portion is corresponding to a selected terminal attached to said substrate.

3. The RJ modular connector as recited in claim 2, wherein said conductive trace includes a second portion electrically connected to said first portion and which is arranged such that said second portion is corresponding to another terminal attached to said substrate.

4. A RJ modular connector, comprising:
a housing defining a plug receiving section, and a terminal core receiving section; and
a terminal core received in said terminal core receiving section and configured by at least a plurality of terminals attached to a first substrate with a section of said substrate being parallel to said terminals.

5. The RJ modular connector as recited in claim 4, wherein said first substrate has a conductive loop corresponding to selected terminal to create electrical coupling therebetween.

6. The RJ modular connector as recited in claim 5, wherein said conductive loop is located at a first surface opposite a second surface on which said terminals are attached thereto.

7. The RJ modular connector as recited in claim 5, wherein said conductive loop is arranged to corresponding to said selected terminal and spaced by a portion of said first substrate thickness.

8. A RJ modular connector, comprising:
a housing defining a plug receiving section, and a terminal core receiving section;
a terminal core received in said terminal core receiving section and including a plurality of terminals;
a first substrate provided having conductive trace thereon, electrical connection established between a third terminal and said conductive trace, and portion of said conductive trace being arranged to create a first electrical coupling between said third and first terminals thereby helping to balance a second electrical coupling between said third terminal and a second terminal arranged between said third and first terminals.

9. The RJ modular connector as recited in claim 8, wherein said first, second and third terminals are arranged in the same plane.

10. The RJ modular connector as recited in claim 8, wherein a portion of said conductive trace is in parallel to said first terminal.

11. The RJ modular connector as recited in claim 8, wherein said third terminal further establish a third electrical coupling between said third terminal and a fifth terminal by a second conductive trace formed on said substrate.

12. The RJ modular connector as recited in claim 11, wherein said third electrical coupling is used to balance a fourth electrical coupling created between third terminal and a fourth terminal located between said third and fifth terminals.

13. The RJ modular connector as recited in claim 11, wherein said second conductive trace is electrically connected to said first conductive trace.

14. The RJ modular connector as recited in claim 13, wherein said first and second conductive traces are dielectrically surrounded by said grounding plane.

15. The RJ modular connector as recited in claim 12, further including a sixth terminal establishing a fifth electrical coupling with respective to fourth terminal by means of a third conductive trace formed on a second substrate attached to said terminals and sandwiching said terminals between said first and second substrates.

16. The RJ modular connector as recited in claim 15, wherein said fifth electrical coupling is used to balance a sixth electrical coupling created between said sixth and fifth terminals.

17. The RJ modular connector as recited in claim 16, wherein said sixth terminal establishes a seventh electrical coupling with respect to an eighth terminal by means of a fourth conductive trace connected to said third conductive trace of said second substrate.

18. The RJ modular connector as recited in claim 17, wherein said seventh electrical coupling is used to balance an eighth electrical coupling created between said sixth terminal and a seventh terminal located between said sixth and eighth terminals.

19. A RJ modular connector, comprising:
a housing defining a plug receiving section and a terminal core receiving section; and
a terminal core received in said terminal core receiving section, said terminal core including at least two pairs of terminals attached to a substrate having conductive portions for connecting said terminals and a conductive trace corresponding to a selected conductive portion, wherein coupling through conductive trace with respect to said selected conductive portion between different terminals is established so as to help to balance couplings from adjacent terminals.

20. A method for compensating impedance arrangement among terminals, comprising the steps of:
providing at least three terminals successively labeled with numbers one, two, three in sequence, wherein to terminal one terminal two is right adjacent thereto with relatively significant impedance effect upon terminal one, while terminal three farther away from terminal one than terminal two with relative insignificant impedance effect upon terminal one;
providing a printed circuit board with traces thereon; and
electrically connecting terminal one to said traces while simultaneously having traces closer to, but not in contact with, terminal three than terminal two with more coupling thereof so as to compensating for or counterbalancing impedance effect imposed upon terminal one by terminal two.
